(19) United States
(12) Patent Application Publication
(10) Pub. No.: US 2021/0327285 A1
(43) Pub. Date: Oct. 21, 2021

(54) FLIGHT PROCESSING METHOD AND CONTROL DEVICE, UNMANNED AERIAL VEHICLE, SERVER, AND SMART TERMINAL

(71) Applicant: SZ DJI TECHNOLOGY CO., LTD., Shenzhen (CN)

(72) Inventors: Shu WANG, Shenzhen (CN); Ruiyi ZHU, Shenzhen (CN); Hongzhu ZHOU, Shenzhen (CN)

(21) Appl. No.: 17/361,632

(22) Filed: Jun. 29, 2021

Related U.S. Application Data
(63) Continuation of application No. PCT/CN2018/125830, filed on Dec. 29, 2018.

(51) Int. Cl. G08G 5/00; G05D 1/10

(52) U.S. Cl. CPC G08G 5/0013; G05D 1/106; G08G 5/006; G08G 5/0069; G08G 5/0026

(57) ABSTRACT

The present disclosure provides a flight processing method applied to a control device of an unmanned aerial vehicle (UAV). The method includes obtaining a clearance permission file of a target flight restriction area from a server, the clearance permission file being generated by the server in response to flight clearance application information of the flight restriction removal conditions obtained from a smart terminal; and removing flight restrictions of the UAV in the target flight restriction area based on the clearance permission file.

### CROSS-REFERENCE TO RELATED APPLICATIONS

This application is a continuation of International Application No. PCT/CN2018/125830, filed on Dec. 29, 2018, the entire content of which is incorporated herein by reference.

### TECHNICAL FIELD

The present disclosure relates to the technical field of unmanned aerial vehicles (UAVs) and, more specifically, to a flight processing method and control device, a UAV, a server, and a smart terminal.

### BACKGROUND

UAVs are gaining popularity in recent years. To ensure the flight safety of UAVs and the safety of personnel and property in related areas, regulatory agencies have increased the supervision of UAVs, requiring UAVs to obtain flight permits from regulatory agencies before taking off. As such, in order to protect the safety of aviation flights, UAV manufacturers are putting UAV flight restriction functions in place in accordance with regulatory requirements. However, there may be situations where the user has obtained the flight permit from the regulatory agency, but still cannot reasonably and legally use the UAV. Therefore, there is a need to enable users who have obtained flight permits to easily remove the corresponding flight restriction functions.

### SUMMARY

One aspect of the present disclosure provides a flight processing method applied to a control device of an unmanned aerial vehicle (UAV). The method includes obtaining a clearance permission file of a target flight restriction area from a server, the clearance permission file being generated by the server in response to flight clearance application information of the flight restriction removal conditions obtained from a smart terminal; and removing flight restrictions of the UAV in the target flight restriction area based on the clearance permission file.

Another aspect of the present disclosure provides a flight processing method applied to a server. The method includes obtaining flight clearance application information submitted by a smart terminal, the flight clearance application information being generated by the smart terminal based on a designated target flight restriction area; generating a clearance permission file for the target flight restriction area in response to the flight clearance application information; and sending the clearance permission file to a control device for the control device to remove flight restriction of a UAV in the target flight restriction area based on the clearance permission file.

Another aspect of the present disclosure provides a flight processing method applied to a smart terminal. The method includes obtaining a target flight restriction area designated by a user; generating flight clearance application information based on the target flight restriction area designated by the user, and sending the flight clearance application information to a server. The flight clearance application information is used to instruct the server to generate a clearance permission file for the target flight restriction area based on the flight clearance application information, and the clearance permission file is used to remove flight restrictions of a UAV in the target flight restriction area.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1A is a schematic structural diagram of a flight processing system according to an embodiment of the present disclosure.

FIG. 1B is a schematic structural diagram of another flight processing system according to an embodiment of the present disclosure.

FIG. 2 is a flowchart of a flight processing method according to an embodiment of the present disclosure.

FIG. 3 is a flowchart of a method for obtaining clearance configuration information according to an embodiment of the present disclosure.

FIG. 4 is a flowchart of the flight processing method according to another embodiment of the present disclosure.

FIG. 5 is a flowchart of the flight processing method according to another embodiment of the present disclosure.

FIG. 6A is an application scenario diagram of the flight processing method on a UAV according to an embodiment of the present disclosure.

FIG. 6B is another application scenario diagram of the flight processing method on the UAV according to an embodiment of the present disclosure.

FIG. 7A is an application scenario diagram of the flight processing method on a server according to an embodiment of the present disclosure.

FIG. 7B is another application scenario diagram of the flight processing method on the server according to an embodiment of the present disclosure.

FIG. 7C is another application scenario diagram of the flight processing method on the server according to an embodiment of the present disclosure.

FIG. 7D is another application scenario diagram of the flight processing method on the server according to an embodiment of the present disclosure.

FIG. 8A is a schematic diagram of an interface on a terminal side according to an embodiment of the present disclosure.

FIG. 8B is a schematic diagram of another interface on the terminal side according to an embodiment of the present disclosure.

FIG. 8C is a schematic diagram of another interface on the terminal side according to an embodiment of the present disclosure.

FIG. 9 is a schematic structural diagram of a flight processing device according to an embodiment of the present disclosure.

FIG. 10 is a schematic structural diagram of another flight processing device according to an embodiment of the present disclosure.

FIG. 11 is a schematic structural diagram of another flight processing device according to an embodiment of the present disclosure.

FIG. 12 is a schematic structural diagram of a control device according to an embodiment of the present disclosure.

FIG. 13 is a schematic structural diagram of a UAV according to an embodiment of the present disclosure.

FIG. 14 is a schematic structural diagram of a server according to an embodiment of the present disclosure.

FIG. 15 is a schematic structural diagram of a smart terminal according to an embodiment of the present disclosure.

### DETAILED DESCRIPTION OF THE EMBODIMENTS

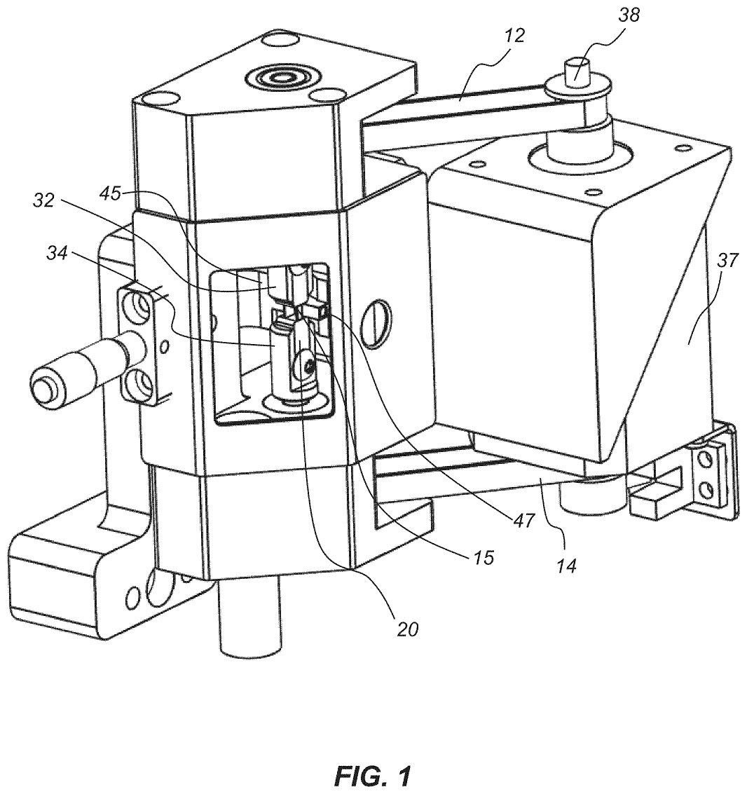

Embodiments of the present disclosure provide a flight processing system. The flight processing system can apply, transmit, and configure clearance configuration information electronically. Referring to FIG. 1A, the flight processing system includes a control device 101, a server 102, and a smart terminal 103. The control device 101 can be set on a UAV, or in other embodiments, the control device 101 can be set on a ground control terminal that controls the UAV, such as the smart terminal 103 or other ground terminals. Of course, the smart terminal 103 can also be a simple terminal that is not being used to control the UAV, but can perform data transmission or information configuration on the UAV. In the embodiment shown in FIG. 1, the smart terminal 103 is disposed on a UAV.

The control device 101 can be used to obtain a clearance permission file of a target flight restriction area from the server 102. The clearance permission file can be an electronic file in a predetermined format, and the control device 101 can configure the UAV for flight based on the clearance permission file. The server 102 can be used to receive the flight clearance application information submitted by the smart terminal 103 or the user through other means, review the flight clearance application, and generate a clearance permission file. The smart terminal 103 can be configured to generate the flight clearance application information based on the target flight restriction area designated by the user, and send the flight clearance application information to the server 102.

In some embodiments, as shown in FIG. 1A, the interaction between the control device 101, the server 102, and the smart terminal 103 is as follow. The smart terminal 103 generates the flight clearance application information based on the target flight restriction area designated by the user, and sends the flight clearance application information to the server 102. After the server 102 receives the flight clearance application information, the server 102 reviews whether the flight clearance application information meets the flight restriction removal conditions for the target flight restriction area, and generates a clearance permission file after passing the review. The server 102 can send the clearance permission file to the smart terminal 103 as needed, and the user can check through the smart terminal 103. The control device 101 can also log into the server 102 to download the clearance permission file, and can also configure the UAV based on the clearance permission file after downloading the clearance permission file.

In FIG. 1A, the flight clearance application information is submitted by the smart terminal 103. In other embodiments, the flight clearance application information can also be submitted through the control device 101. For example, the smart terminal 103 may collect the information required for the flight clearance application information, and send the required information (or the flight clearance application information generated based on the required information) to the control device, and the control device can send the required information to the server. Alternatively, as the ground control terminal, the control device itself may include the functions of collecting the information required for the flight clearance application information (e.g., the collection of the target flight restriction area information used to indicate the target flight restriction area), and processing and sending the flight clearance application information to the server. In addition, the user can also directly download the clearance permission file from the server 102 through the control device in the UAV, and perform flight configuration of the UAV based on the clearance permission file to remove the flight restriction on the UAV in the target flight restriction area. As shown in FIG. 1B, which is another flight system according to an embodiment of the present disclosure, and the control device is disposed in a smart terminal 104. The smart terminal 104 or the control device can collect the information required for the flight clearance application information, and submit the flight clearance application information. After a server 106 generates the clearance permission file, the smart terminal 104 can download and receive the clearance permission file, and configure a UAV 105 based on the clearance permission file when needed to remove the flight restriction of the UAV 105 in certain flight restriction areas.

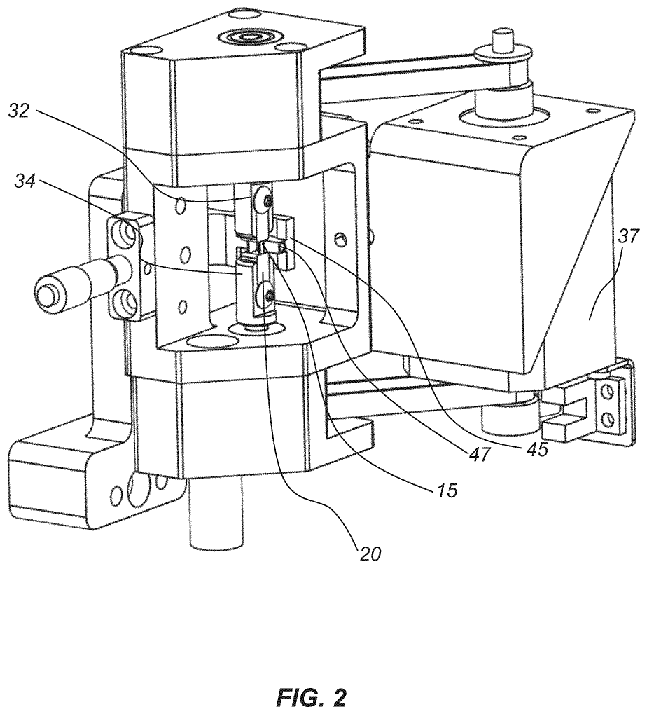

The working principle of a flight management method shown in FIG. 2 will be described in detail below in conjunction with FIG. 1A and FIG. 1B. The flight management method according to an embodiment of the present disclosure can be executed by the control device 101 shown in FIG. 1. The method will be described in detail below.

S201, the control device obtains the clearance permission file of the target flight restriction area from the server, the clearance permission file may be generated by the server in response to the flight clearance application information of the target flight restriction area obtained from the smart terminal. The clearance permission file can be used to remove the flight restriction of the UAV in the target flight restriction area. The clearance permission file of the target flight restriction area may be an electronic clearance permission file, which can be an electronic file generated by the server in response to the flight clearance application information of the target flight restriction area obtained from the smart terminal. It can be understood that the electronic clearance permission file may correspond to one or more electronic file formats, and the electronic file formats can be analyzed by the control device and the server to obtain specific content for removing the flight restriction of the UAV in the target flight restriction area. The content of the clearance permission file may include, but is not limited to, target flight restriction area information, UAV identification, user information, and the validity period of the clearance permission file, etc. In some embodiments, the target flight restriction area information may include, but is not limited to, the UAV's flight altitude limit, flight distance limit, flight time limit, and takeoff prohibition restrictions, etc. The control device can download the clearance permission file including the corresponding UAV identification or user information from the server based on the UAV identification or user information. The validity period of the clearance permission file can be used to determine whether the clearance permission file is within the validity period.

S202, the control device removes the flight restriction of the UAV in the target flight restriction area based on the clearance permission file. In some embodiments, the control device may analyze the clearance permission file to configure the UAV to fly, thereby removing the flight restriction of the UAV in a target flight restriction area. The clearance permission file may be generated by the server based on a packaging rule negotiated by the control device, server, and smart terminal, and encrypted based on certain encryption rules to ensure that the clearance permission file can be safely transmitted and correctly analyzed. After receiving the clearance permission file, the control device can write the target flight restriction area and the validity period in the clearance permission file into a flight controller of the UAV as configuration information, such that the flight controller can automatically remove the flight restriction of the UAV in the target flight restriction area within the validity period based on the configuration information.

In the embodiments of the present disclosure, the process of removing the flight restriction of the UAV in a certain target flight restriction area can be electronic defined, such that the removal process can be automatically completed through electronic operations. As such, the flight clearance process of the UAV is more efficient, and the situation where the user has obtained the flight permit but still cannot reasonably and legally use the UAV can be avoided.

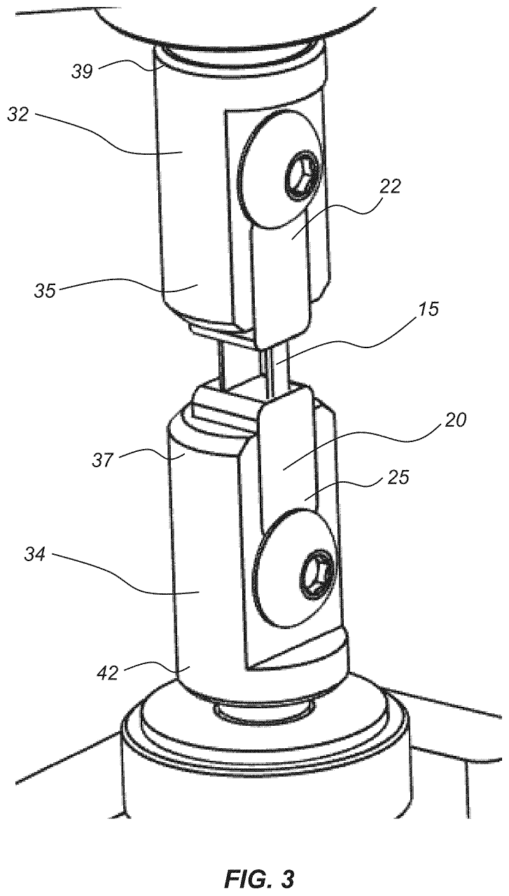

Referring to FIG. 3, which is a flowchart of a method for removing flight restrictions based on the clearance permission file according to an embodiment of the present disclosure. In the embodiments of the present disclosure, after obtaining the clearance permission file described above, the control device can perform the corresponding operations on the UAV to facilitate the removal of the UAV's flight restrictions. As shown in FIG. 1A, the control device can directly obtain the clearance permission file from the server 102. As shown in FIG. 1B, the control device can also obtain the clearance permission file from the smart terminal 104. The method for removing the flight restrictions based on the clearance permission file may correspond to the process at S202, which will be described in detail below.

S301, the control device determines whether to remove the flight restriction of the UAV. In the embodiments of the present disclosure, whether to remove the flight restriction of the UAV can be determined from multiple aspects, such as from the controlling user who controls the UAV, from the current position of the UAV, from the current time when the UAV needs to be controlled, and from the model or identification of the UAV that needs to fly.

S302, the control device removes the flight restriction of the UAV in the target flight restriction area based on the clearance permission file.

In some embodiments, the process at S301 may include extracting the target flight restriction area information from the clearance permission file; obtaining the current position information of the UAV; and performing the process of removing flight restriction of the UAV when the position indicated by the current position information of the UAV is within the target flight restriction area indicated by the target flight restriction area information, and the target flight restriction area is within the flight restriction area indicated by the built-in flight restriction information of the UAV. That is, as long as the UA that needs to fly reach the flight restriction area, and the flight restriction area is the area indicated in the clearance permission file that allows the UAV to be cleared, after reaching such an area, the control device of the UAV can automatically remove the flight restriction of the UAV in the target flight restriction area based on the clearance permission file. It can be understood that in some cases, at any time before the UAV is required to perform flight tasks in certain flight restriction areas, the flight restriction of the UAV in the corresponding target flight restriction area can be removed based on the obtained clearance permission file.

In some embodiments, the process at S301 may include extracting the clearance identification used to identify the UAV based on the clearance permission file; obtaining the UAV identification of the UAV; comparing the clearance identification with the identification of UAV to determine whether the clearance identification is consistent with the identification of the UAV; and performing the process of removing the flight restriction of the UAV when the clearance identification is consistent with the identification of the UAV. When determining whether to remove the ban of the UAV, the UAVs that are allowed to be cleared in the clearance permission file can be compared with the UAVs that need to be cleared. When the clearance identification is consistent with the identification of the current UAV, the flight restriction of the UAV in the target flight restriction area can be automatically removed based on the clearance permission file. The same identification can be considered that the UAVs that are allowed to be cleared are the same as the UAVs that need to be cleared, and situations where the UAV that originally applied for the clearance permission file is a small and fast rotary-wing UAV, and illegal user uses the clearance permission file to remove the ban on a large and fast fixed-wing UAV will not occur. Of course, it can be understood that in most cases, there may be no difference in size or speed in the flight restriction area. There may only be restrictions on the flight of the UAVs or no restrictions on the flight of the UAVs. In this case, there is no need to perform the comparison process of the clearance identification and the identification of the current UAV described above.

In some embodiments, the process at S301 may include extracting user information based on the clearance permission file; obtaining the control user information of the UAV; comparing the user information with the control user information of the UAV to determine whether the user indicated by the control user information is a legitimate cleared user; and performing the process of removing the flight restriction of the UAV if the user indicated by the control user information is a legitimate cleared user. The user information of the clearance permission file may include user account information and/or user identify information. In some embodiments, when the user information of the clearance permission file includes the user account information, the control user information may correspondingly be a registered account information logged in on a smart terminal or a control device, which can be used to determine whether the user corresponding to the corresponding control user information is a legally registered user. When the user information of the clearance permission file includes the user identity information, the control user information may correspondingly be an identification card number information or qualification certificate number information and other information used to indicate that the user has flight control qualifications, which can be used to determine whether the user corresponding to the control user information is a user who has the flight qualification to control the UAV analysis. For example, the media that applies for live broadcast of certain event scenes is media A, and the regulator allows media A to control the UAV to fly in the target flight restriction area. At this time, before removing the flight restriction of the UAV, the control user information of the control device or the smart terminal used to control the UAV current logged-in can be determined, thereby determining whether the user controlling the flight in the target flight restriction area is a legitimate user. If the user is not a legitimate user, the control device may not automatically remove the flight restriction of the UAV in the target flight restriction area.

In some embodiments, the process at S301 may include extracting the validity period of the clearance permission file based on the clearance permission file; determining whether the current data is within the validity period; and performing the process of removing the flight restriction of the UAV if the current data is within the validity period. That is, an effective time can be set for the clearance permission to prevent the clearance permission file that has exceeded the validity period from being used, and to ensure that the flight restriction of the UAV is removed in the target flight restriction area in a suitable time. Of course, in other embodiments, the effective time may not be set.

Based on the process described above, the control device may determine whether the obtained clearance permission file is valid for the UAV, such that the control device can subsequently configure the UAV based on the clearance permission file analyzed by the valid clearance permission file to ensure that the clearance permission file is not illegally used. It can be understood that the specific processes at S301 described above may be executed by the control device alone or in combination to determine whether the clearance permission file is an effective clearance permission file for the UAV. For example, whether the current time is within the valid period can be determined first, then whether the position indicated by the current position information of the UAV is within the target flight restriction area indicated by the target flight restriction area, and whether the target flight restriction area is within the flight restriction area indicated by the built-in flight restriction information of the UAV can be determined. In some embodiments, two or more combinations to determine whether to remove the flight restriction of the UAV can be selected based on needs.

In some embodiments, the target flight restriction area in the clearance permission file may define configuration information such as the UAV's flight area, flight attitude and/or flight time, and the control device may modify the current restricted flight altitude, flight distance, flight time and/or prohibited takeoff area of the UAV based on the clearance permission file to remove the flight restriction of the UAV in the target flight restriction area. In one embodiment, the control device may extract the configuration information of the UAV's permitted flight altitude, permitted flight distance, permitted flight time, and permitted takeoff area from the clearance permission file, and compare the configuration information with the relevant prohibited flight items in the UAV's flight controller, thereby removing the flight restriction of the UAV in the target flight restriction area. For example, the coordinate area where a certain bus station is located may be recorded in the prohibited flight items in the original flight controller. When configuring based on the clearance permission file, the coordinate area where the bus station is located may be located and deleted from the prohibited flight items in the flight controller based on configuration information in the clearance permission file. Of course, there are other ways to configure the flight controller of the UAV based on the information in the clearance permission file, which can be used in special clearance permission files, and will not be described in detail here.

In some embodiments, the control device may also control the UAV in accordance with the safety policy included in the clearance permission file to ensure the flight safety of the UAV. The safety policy included in the clearance permission file may include, but is not limited to, setting a monitoring time node, collecting information about the UAV's flight area, collecting the voltage state of the UAV, etc. The UAV may modify the authorized flight area of the UAV based on the clearance permission file, but there may be situations in which the UAV approaches or erroneously enters other restricted flight areas during the flight. In this case, the control device may need to control the UAV based on the safety policy included in the clearance permission file. For example, a plurality of monitoring time nodes can be set, and each monitoring time node may collect the flight area information of the UAV. If the UAV is close to other cleared flight areas, the UAV can be controlled to automatically return. In another example, the battery state of the UAV may be collected at each monitoring time node, and the UAV can be controlled to return if the UAV is in a low batter state.

Consistent with the present disclosure, the control device can determine whether to remove the UAV's flight restriction, remove the UAV's flight restriction in the target flight restriction area based on the clearance permission file, configure the flight of the UAV based on the configuration information included in the clearance permission file, and control the UAV based on the safety policy included in the clearance permission file. In this way, the flight restriction of the UAV can be removed in the target flight restriction area in an electronic operations, and the control device can directly download the clearance permission file from the server, making the flight restriction removal process of the UAV more efficient. Further, the safety of the flight of the UAV can be controlled based on the safety policy in the clearance permission file, which ensures the flight safety of the UAV.

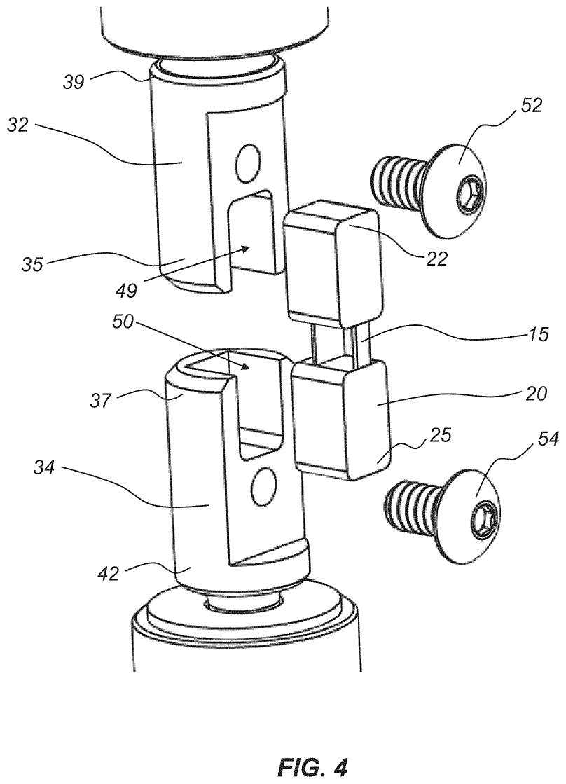

FIG. 4 is a flowchart of the flight processing method according to another embodiment of the present disclosure. The method shown in FIG. 4 can be executed by the server shown in FIG. 1. The method will be described in detail below.

S401, the server obtains the flight clearance application information submitted by the smart terminal, the flight clearance application information being generated by the smart terminal based on the designated target flight restriction area. The smart terminal may be the terminal shown in FIG. 1A or FIG. 1B. The flight clearance application information may include, but is not limited to, the user information, the target flight restriction area information, the UAV identification, and the validity period of the flight clearance application information. The submitted user information may include the registered user information legally registered in the server or other designated servers. In one embodiment, the user information may be used to log into the server to submit the flight clearance application. The user information may also include the user identity information, which can be used to identify whether the user has the flight qualification to operate the UAV. The target flight restriction area information can be used to indicate the designated target flight restriction area. In other embodiments, the target flight restriction area information may also include information such as flight time as required, and the target flight restriction area information can be used to remove the flight restriction in the area designated by the user. The UAV identification can be used to specify the UAV associated with the user. Based on the UAV identification, the model of the UAV can be determined. The validity period of the flight clearance application information can be used to determine the time validity of the flight clearance application.

The flight clearance application information can be generated by the smart terminal or control device based on the designated target flight restriction area and submitted to the server. The server can receive the flight clearance application information and process the flight clearance application information accordingly. In practice, the server may refer to the relevant function server of the flight supervision department of the UAV, for example, the relevant function server of the Civil Aviation Administration of China.

S402, the server responds to the flight clearance application information, and generate a clearance permission file for the target flight restriction area. After obtaining the flight clearance application information submitted by the smart terminal, in response to the flight clearance application information, the server can determine whether the flight restriction removal condition for the target flight restriction area is satisfied. If the flight restriction removal condition for the target flight restriction area is satisfied, the application for clearance the flight is approved, and a clearance permission file for the target flight restriction area can be generated. Whether the conditions for removing the ban on the target flight restriction area are met can be determined based on the flight clearance application information, which can be manually reviewed by the flight supervision department of the UAV, or the server can compare the flight clearance application information with the conditions for removing the ban on the flight restrictions of the target flight restriction area.

In some embodiments, the process at S402 may include displaying the flight clearance application information on an interactive interface; determining whether an approval instruction for the flight clearance application information is received; if the approval instruction is received, the conditions for removing the flight restriction on the clearance identification are met. Based on the above processes, if the manual review is passed, the flight clearance application information can be determined as meeting the flight restriction removal condition for the target flight restriction area, and the sever can generate the clearance permission file for the target flight restriction area to remove the flight restriction of the UAV.

In some embodiments, the process at S402 may include analyzing the flight clearance application information, and determining whether the analyzed information meets the flight restriction removal conditions for the target flight restriction area; and if the analyzed information meets the flight restriction removal conditions for the target flight restriction area, the conditions for removing the flight restriction on the clearance identification are met. In one embodiment, analyzing the flight clearance application information, and determining whether the analyzed information meets the flight restriction removal conditions for the target flight restriction area may include analyzing the flight clearance application information and determining whether the analyzed flight coordinate range falls within a coordinate range of the target flight restriction area, and determining the flight restriction removal conditions are met if the analyzed flight coordinate range falls within the coordinate range of the target flight restriction area. Alternatively, analyzing the flight clearance application information, and determining whether the analyzed information meets the flight restriction removal conditions for the target flight restriction area may include analyzing the flight clearance application information, and determining whether the analyzed UAV identification is the identification of a

UAV that has been legally registered. The UAV identification that has been registered can be obtained in advance. If the analyzed UAV identification is the identification of a UAV that has been legally registered, the flight restriction removal conditions are considered as met. Further, analyzing the flight clearance application information, and determining whether the analyzed information meets the flight restriction removal conditions for the target flight restriction area may include analyzing the flight clearance application information, and determining whether the user information obtained by the analysis is the information of a legitimate control user. The information of the legitimate control user can be obtained in advance. If the user information obtained by the analysis is the information of a legitimate control user, the flight restriction removal conditions are considered as met. Based on the above processes, the server can automatically analyze the received flight clearance application information, and replace the processes of manual review. If the flight clearance application information meets the flight restriction removal conditions for the target flight restriction area, the server can automatically generate the clearance permission file for the target flight restriction area. In some embodiments, the user information of the flight clearance application information may include the user account information and/or the user identity information. When the user information of the flight clearance application information includes the user account information, the server can determine whether the user corresponding to the user information in the flight clearance application information is a legitimate registered user. When the user information of the flight clearance application information includes the user identity information, the server can determine whether the user corresponding to the user information in the flight clearance application information is a user who has the flight qualification to control the UAV analysis. If the user corresponding to the user information in the flight clearance application information is a user who has the flight qualification to control the UAV analysis, the flight restriction removal conditions are considered as met.

Similarly, it can be understood that the server can comprehensively determine whether the flight clearance application information meets the flight restriction removal conditions based on any one or a combination of the determination methods described above.

In some embodiments, if the flight clearance application information submitted by the smart terminal does not meet the flight restriction removal conditions for the target flight restriction area, the server may modify the flight clearance application information submitted by the smart terminal based on the flight restriction removal conditions of the target flight restriction area to generate the clearance permission file. In some embodiments, the process at S402 may include determining whether the flight coordinate range included in the flight clearance application information belongs to the authorized flight coordinate range of the target flight restriction area; and, if the flight coordinate range included in the flight clearance application information does not belong to the authorized flight coordinate range of the target flight restriction area, modifying the target flight restriction area in the flight clearance application information based on the authorized flight coordinate range of the target flight restriction area, and generating the clearance permission file based on the modified target flight restriction area. Based on the above processes, the server can modify the flight clearance application information submitted by the smart terminal, such that the flight clearance application information can meet the flight restriction removal conditions of the target flight restriction area, which improves the passing rage and efficiency of the flight clearance application for removing the flight restrictions of UAVs in the target flight restriction areas.

S403, the server sends the clearance permission file to the control such that the control device can remove the UAV's flight restriction in the target flight restriction area based on the clearance permission file. After the server generates the clearance permission file, it may be needed to ensure that the content included in the clearance permission file can be analyzed by the UAV, and to ensure that the clearance permission file is encrypted to a certain degree and can be transmitted via the Internet. At the same time, the server can send the clearance permission file to the smart terminal, and the user can view the specific content of the clearance permission file.

Consistent with the present disclosure, the server can generate the clearance permission file, and devices such as smart terminals and control devices can view and download the clearance permission file, thereby realizing the entire electronic operation, making the business processing process more efficient.

FIG. 5 is a flowchart of the flight processing method according to another embodiment of the present disclosure, which can be executed by the smart terminal shown in FIG. 1. The method will be described in detail below.

S501, the smart terminal obtains the target flight restriction area designated by the user. A business application (APP) can be installed in the smart terminal, and the user can log into the business APP and submit the flight clearance application information on a user application interface. The smart terminal can obtain the target clearance area designated by the user by detecting the designated target flight restriction area submitted by the user on the user application interface.

In some embodiments, the smart terminal may obtain the area information set by the user on an area map displayed on the user application interface. The area map displayed on the user application interface can be marked with area information of the target flight restriction area, and the smart terminal can obtain the target flight restriction area submitted by the user based on the area information set on the area map. The area that the user applies for removing the flight restriction can be an area that the user marked on the area map by inputting information such as the longitude, latitude, flight altitude, and other coordinate information of the area for the flight ban removal based on the area map. Alternatively, the user can select coordinate points on the area map, and use the area enclosed by the coordinate points as the target flight restriction area. For example, the user can click to confirm three points, four points, or more points in the target flight restriction area on the user application interface, and obtain relevant coordinate information based on the closure of these points to determine the target flight restriction area. In other embodiments, the smart terminal may obtain the area selected by the user on the user application interface that is listed as the flight restricted area. In some embodiments, when the user selects the target flight restriction area on the user application interface, the entire area listed as the flight restriction area listed as the flight restriction area displayed on the user application interface can be directly selected as the target flight restriction area.

S502, the smart terminal generates the flight clearance application information based on the target flight restriction area designated by the user, and sends the flight clearance application information to the server. The smart terminal can obtain the target flight restriction area submitted by the user, and determine whether the target flight restriction area designated by the user is a flight restricted area based on the user information. If the target flight restriction area designated by the user is a flight restricted area, then the flight clearance application information can be generated by the target area designated by the user. The flight clearance application information can be used to instruct the server to generate a clearance permission file for the target flight restriction area based on the flight clearance application information, and the clearance permission file can be used to instruct the UAV to removal the flight restriction in the target flight restriction area.

Consistent with the present disclosure, the smart terminal can obtain the target flight restriction area designated by the user, generate the flight clearance application information based on the target flight restriction area designated by the user, and send the flight clearance application information to the server. The flight clearance application information can be used to instruct the server to generate a clearance permission file for the target flight restriction area based on the flight clearance application information, and the clearance permission file can be used to instruct the UAV to removal the flight restriction in the target flight restriction area. In this way, the user can submit the flight clearance application information on the target flight restriction area through the smart terminal, realize the entire electronic operation, which makes the business processing process more efficient.

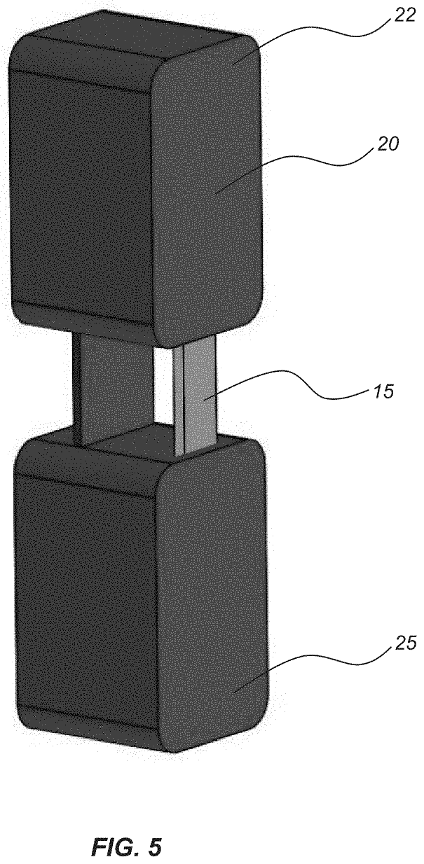

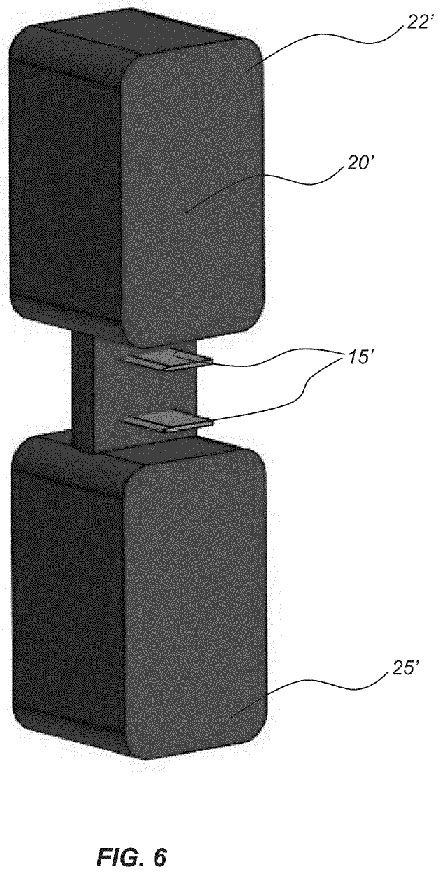

Based on the flight processing method executed by the control device described above, an embodiment of the present disclosure provides an application scenario of the flight processing method. Referring to FIG. 6A to FIG. 6B, take the control device as a part of the UAV set on the UAV as an example, the UAV may be configured to log into the server through the control device, and download the clearance permission file. As shown in FIG. 6A, the UAV analyzes the clearance permission file through the control device, and obtains the information included in the clearance permission file. As shown in FIG. 6B, the UAV uses the control device to configure the UAV based on the clearance permission file. After the UAV configuration is completed, the preset flight restrictions can be removed, such that the UAV can fly in the flight restricted area.

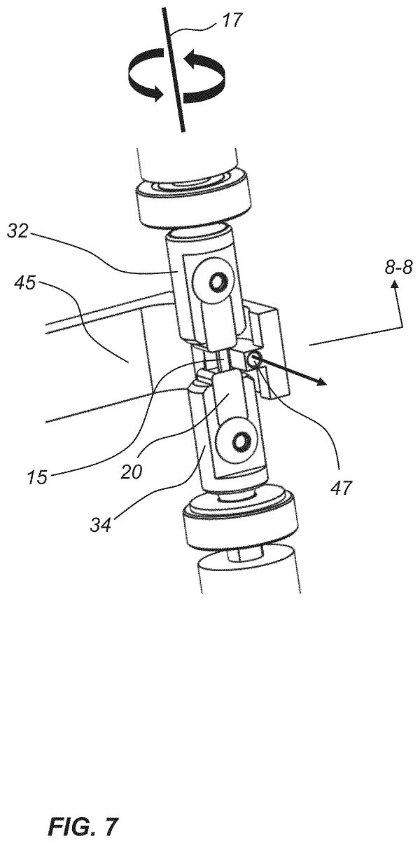

Based on the flight processing method executed by the server described above, an embodiment of the present disclosure provides an application scenario of the flight processing method. Referring to FIG. 7A to FIG. 7D, as shown in FIG. 7A, the smart terminal submits the flight clearance application information to the server. After the server performs the corresponding processing, the smart terminal can download the clearance permission file. The processing on the server side may include obtaining the flight clearance application information submitted by the smart terminal, which can be displayed to the user through the corresponding display on the server side. Further, the server can also automatically analyze the flight clearance application information submitted by the smart terminal. FIG. 7B to FIG. 7D take the display of the flight clearance application information to the user as an example. In some embodiments, the flight clearance application information may include the user information, UAV serial number, designated target flight restriction area, etc. If the flight clearance application information submitted by the smart terminal does not meet the preset conditions of the flight restriction in the target flight restriction area, the server may modify the flight clearance application based on the preset conditions. As shown in FIG. 7B and FIG. 7C, the modification process can be handled by the server itself or manually modified by the user. As shown in FIG. 7D, after the modification is completed, the server can generate the clearance permission file. After clicking on the confirm button, the server will store the clearance permission file in the internal space, and the smart terminal and/or the UAV can log into the server to view or download the clearance permission file.

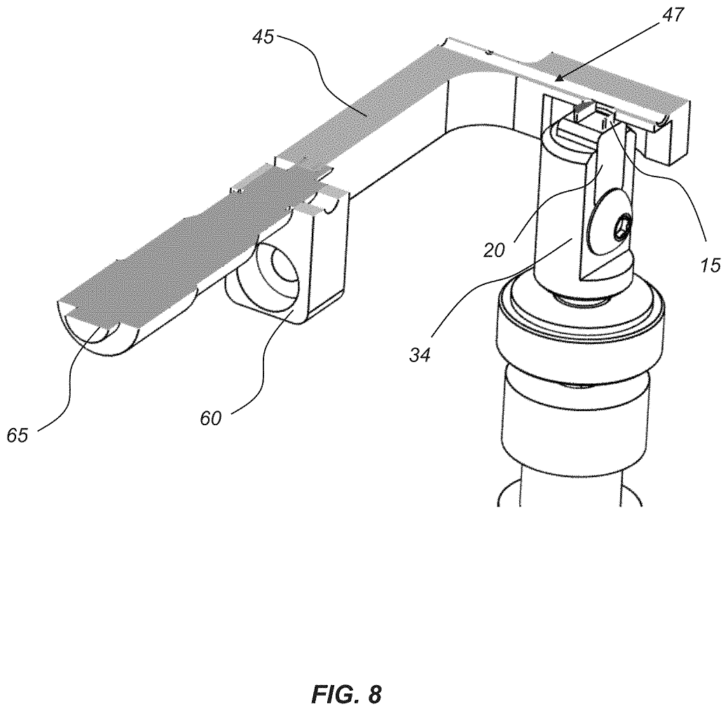

Based on the flight processing method executed by the smart terminal described above, an embodiment of the present disclosure provides an application scenario of the flight processing method. Referring to FIG. 8A to FIG. 8C, an APP that can execute the flight permission method can be installed on the side of the smart terminal, such as a mobile phone. The process of running the APP may include the user opening the APP that executes the flight application method, entering the user name, login password, UAV serial number (e.g., the UAV identification), and clicking the log in button. As shown in FIG. 8A, after the user logs in, the interface will display an area map, which includes the UAV's restricted flight area, the flight altitude limit, the flight time limit, and other information. As shown in FIG. 8B, the user can select the target flight restriction area on the area map displayed on the interface, such as marking coordinate points, and connecting the marked coordinate points into an enclosed area. Alternatively, as shown in FIG. 8C, the user can directly select the flight restriction area that needs to be cleared based on the flight restriction area displayed on the area map. After completing the above processes, the smart terminal can generate the flight clearance application information based on the information submitted by the user, and submit the flight clearance application information to the server.

Based on the foregoing description of the embodiments of the flight processing method that can be executed by the control device, an embodiment of the present disclosure provides a flight processing device. The device can be operated in a UAV or a control device, and can be used to execute the corresponding processes in the flight processing method shown in FIG. 2 and FIG. 3.

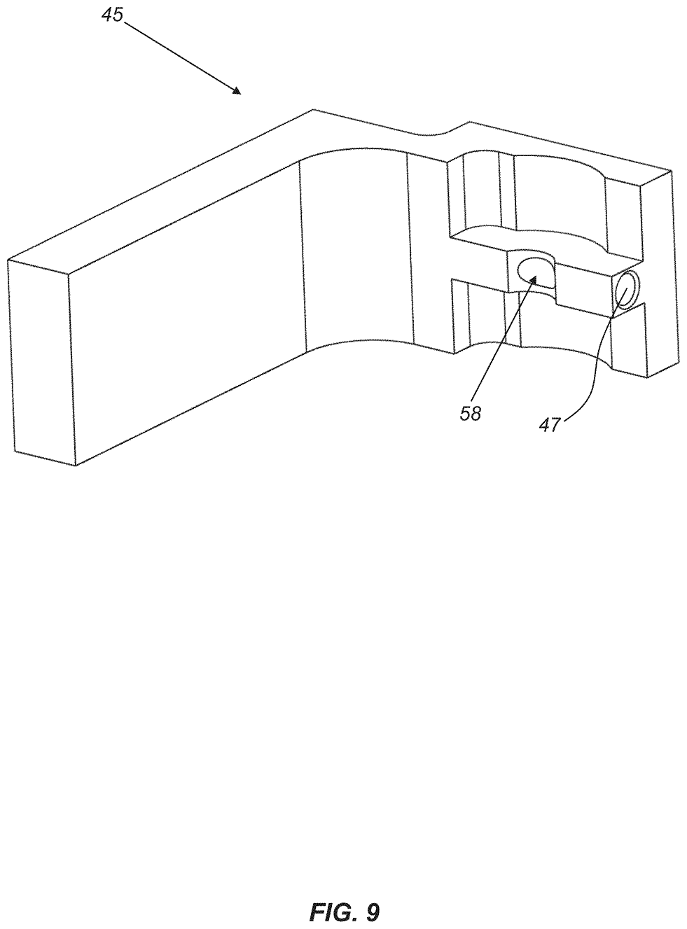

Referring to FIG. 9, the flight processing device includes an acquisition module 901 configured to obtain the clearance permission file of the target flight restriction area from the server. The clearance permission file can be generated by the server in response to the flight clearance application information of the target flight restriction area obtained from the smart terminal. The flight processing device also includes a processing module 902 configured to remove the flight restriction of the UAV in the target flight restriction area based on the clearance permission file.

In some embodiments, the processing module 902 may be configured to extract the target flight restriction area information based on the clearance permission file, obtain the current location information of the UAV, and execute the clearance permission file to remove the flight restriction of the UAV in the target flight restriction area when the position indicated by the current position information of the UAV is within the target flight restriction area indicated by the target flight restriction area information, and the target flight restriction area is within the flight restriction area indicated by the built-in flight restriction information of the UAV.

In some embodiments, the processing module 902 may be configured to extract the clearance identification used to identify the UAV based on the clearance permission file, obtain the UAV identification of the UAV, compare the clearance identification with the UAV identification to determine whether the clearance identification is consistent with the UAV identification, and execute the clearance permission file to remove the flight restriction of the UAV in the target flight restriction area based on the clearance permission file if the clearance identification is consistent with the UAV identification.

In some embodiments, the processing module 902 may be configured to extract the user information based on the clearance permission file, obtain the control user information of the UAV, compare the user information with the control user information of the UAV to determine whether the user is the control user of the UAV, and execute the clearance permission file to remove the flight restriction of the UAV in the target flight restriction area based on the clearance permission file if the user is the control user of the UAV.

In some embodiments, the processing module 902 may be configured to extract the validity period of the clearance permission file based on the clearance permission file, determine whether the current date is within the validity period, and execute the clearance permission file to remove the flight restriction of the UAV in the target flight restriction area based on the clearance permission file if the current date is within the validity period.

In some embodiments, the acquisition module 901 may be configured to download the clearance permission file from the server based on the UAV identification, or download the clearance permission file from the server based on the control user information of the UAV.

Consistent with the present disclosure, the process of the removing the flight restriction of the UAV can be a complete electronic operation, and the clearance permission file can be downloaded directly from the server, thereby eliminating the manual review process, and making the UAV flight restriction removal process more efficient.

Based on the foregoing description of the embodiments of the flight processing method that can be executed by the server, an embodiment of the present disclosure provides another flight processing device. The device can be operated in a server, and can be used to execute the corresponding processes of the flight processing method shown in FIG. 4.

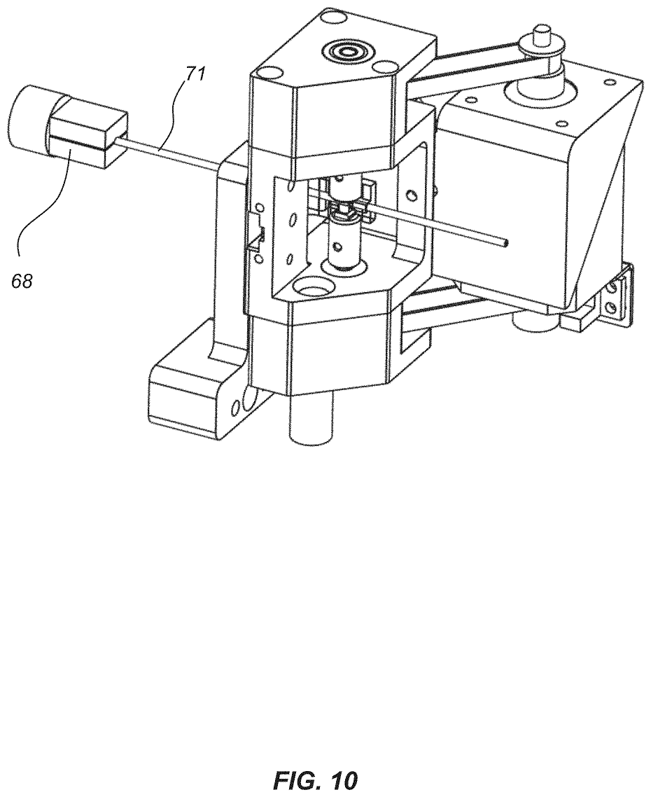

Referring to FIG. 10, the flight processing device includes an acquisition module 1001 configured to obtain the flight clearance application information submitted by the smart terminal, the flight clearance application information can be generated by the smart terminal based on the designated target flight restriction area. The flight processing device further includes a processing module 1002 configured to respond to the flight clearance application information and generate a clearance permission file for the target flight restriction area, and a sending module 1003 configured to send the clearance permission file to the control device such that the control device can remove the flight restriction of the UAV in the target flight restriction area based on the clearance permission file.

In some embodiments, the processing module 1002 may be further configured to, in response to the flight clearance application information, determine whether the flight restriction removal conditions are met. If the flight restriction removal conditions are met, the application for clearance the flight can be approved, and the clearance permission file for the target flight restriction area can be generated.

In some embodiments, the processing module 1002 may be further configured to display the flight clearance application information on the interactive interface, determine whether the approval instruction for the flight clearance application information is received, and consider the flight restriction removal conditions for the target flight restriction area are met if the approval instruction for the flight clearance application information is received.

In some embodiments, the processing module 1002 may be further configured to analyze the flight clearance application information, determine whether the analyzed information meets the flight restriction removal conditions for the target flight restriction area, and consider the flight restriction removal conditions for the target flight restriction area are met if the analyzed information meets the flight restriction removal conditions for the target flight restriction area.

In some embodiments, the processing module 1002 may be further configured to analyze the flight clearance application information, and determine whether the analyzed flight coordinate range falls within the coordinate range of the target flight restriction area; or, analyze the flight clearance application information, and determine whether the analyzed UAV identification is the identification of a UAV that has been legally registered; or, analyze the clearance permission file, and determine whether the user information obtained by the analysis is the information of a legitimate control user.

Consistent with the present disclosure, the server can generate the clearance permission file, and the smart terminal and the control device can view or download the clearance permission file at the same time, thereby realizing the entire electronic operation, eliminating the need for users to request the control device to remove the flight restriction, making the business process more efficient.

Based on the foregoing description of the embodiments of the flight processing method that can be executed by the smart terminal, an embodiment of the present disclosure provides another flight processing device. The device can be operated in a smart terminal, and can be used to execute the corresponding processes of the flight processing method shown in FIG. 5.

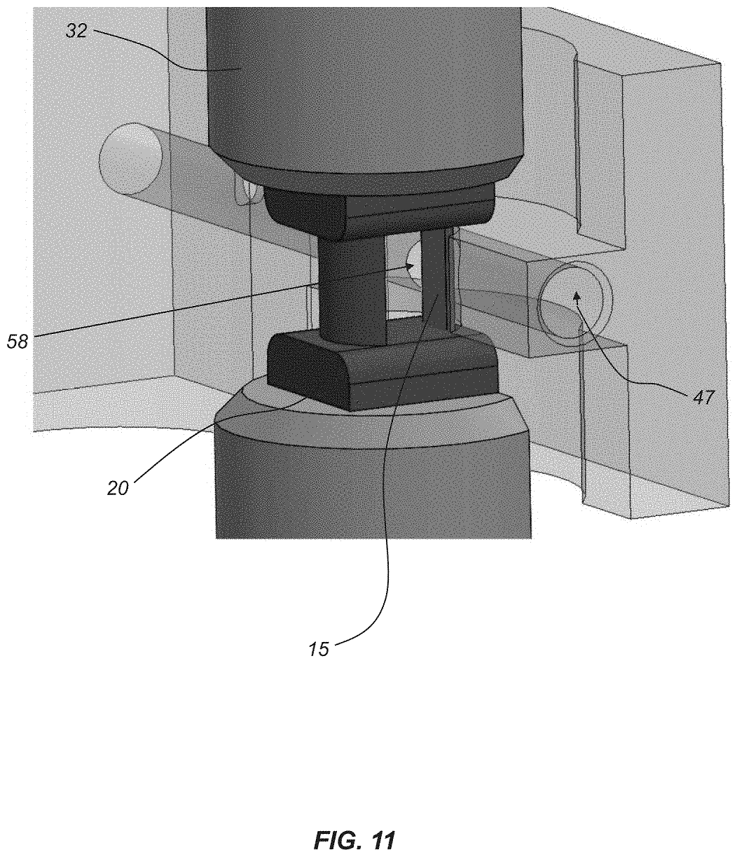

Referring to FIG. 11, the flight processing device includes an acquisition module 1101 configured to obtain the target flight restriction area designated by the user, and a processing module 1102 configured to generate the flight clearance application information based on the target flight restriction area designated by the user, and send the flight clearance application information to the server.

In some embodiments, the acquisition module 1101 may be further configured to obtain the area information set by the user on the area map displayed on the user application interface, the area information of the flight restriction area being marked on the area map displayed on the user application interface; or, obtain the area listed as the flight restricted area selected by the user on the user application interface.

In some embodiments, the processing module 1102 may be further configured to determine whether the target flight restriction area designated by the user is a flight restricted area; and generate the flight clearance application information if the target flight restriction area designated by the user is the flight restricted area. In this way, the user can submit the flight clearance application information on the target flight restriction area through the smart terminal, realize the entire electronic operation, which makes the business processing process more efficient.

For the specific implementation of the corresponding modules in the embodiments corresponding to FIG. 9 to FIG. 11, reference may be made to the description of the relevant content in the embodiments corresponding to FIG. 1 to FIG. 8, which will not be repeated here.

An embodiment of the present disclosure provides a control device, which can be used to implement the flight processing method executed by the control device shown in FIG. 2 and FIG. 3 and the application scenario shown in FIG. 6A to FIG. 6B by implementing the corresponding processes in the flight processing method.

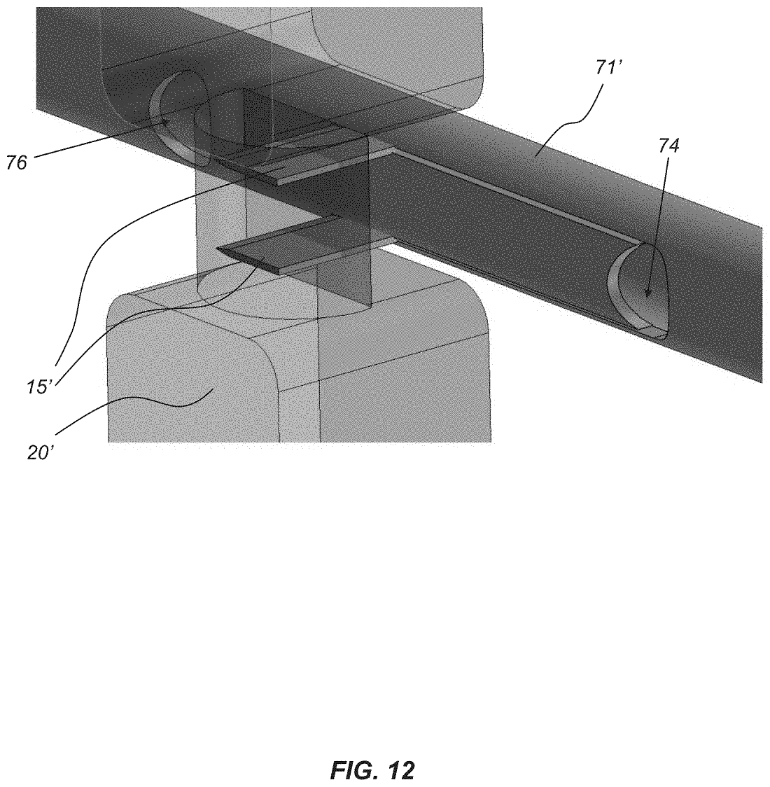

Referring to FIG. 12, the internal structure of the control device includes a communication interface 1201, a processor 1202, and a memory 1203. The communication interface 1201 can be used to establish a communication connection with the UAV, and the memory 1203 can be used to store one or more flight processing instructions. The processor 1202 may be the computing core and the control core of the control device, which is suitable for implementing one or more operating instructions and, more specifically, for loading and executing the one or more flight processing instructions to implement the corresponding workflows or functions.

In some embodiments, the processor 1202 can be configured to execute the program instructions stored in the memory 1203. When executed by the processor 1202, the program instructions can cause the processor 1202 to obtain the clearance permission file of the target flight restriction area from the server, the clearance permission file being generated by the server in response to the flight clearance application information of the target flight restriction area obtained from the smart terminal; and removing the flight restriction of the UAV in the target flight restriction area based on the clearance permission file.

In some embodiments, the program instructions can further cause the processor 1202 to extract the target flight restriction area information based on the clearance permission file, obtain the current location information of the UAV, and execute the clearance permission file to remove the flight restriction of the UAV in the target flight restriction area when the position indicated by the current position information of the UAV is within the target flight restriction area indicated by the target flight restriction area information, and the target flight restriction area is within the flight restriction area indicated by the built-in flight restriction information of the UAV.

In some embodiments, the program instructions can further cause the processor 1202 to extract the clearance identification used to identify the UAV based on the clearance permission file, obtain the UAV identification of the UAV, compare the clearance identification with the UAV identification to determine whether the clearance identification is consistent with the UAV identification, and execute the clearance permission file to remove the flight restriction of the UAV in the target flight restriction area based on the clearance permission file if the clearance identification is consistent with the UAV identification.

In some embodiments, the program instructions can further cause the processor 1202 to extract the user information based on the clearance permission file, obtain the control user information of the UAV, compare the user information with the control user information of the UAV to determine whether the user is the control user of the UAV, and execute the clearance permission file to remove the flight restriction of the UAV in the target flight restriction area based on the clearance permission file if the user is the control user of the UAV.

In some embodiments, the program instructions can further cause the processor 1202 to extract the validity period of the clearance permission file based on the clearance permission file, determine whether the current date is within the validity period, and execute the clearance permission file to remove the flight restriction of the UAV in the target flight restriction area based on the clearance permission file if the current date is within the validity period.

In some embodiments, the program instructions can further cause the processor 1202 to download the clearance permission file from the server based on the UAV identification, or download the clearance permission file from the server based on the control user information of the UAV.

Consistent with the present disclosure, the flight restriction of the UAV can be removed in the target flight restriction area in an electronic operations, and the control device can directly download the clearance permission file from the server, which eliminates the manual review process, making the flight restriction removal process of the UAV more efficient. Further, the safety of the flight of the UAV can be controlled based on the safety policy in the clearance permission file, which ensures the flight safety of the UAV.

An embodiment of the present disclosure provides a UAV, which can be used to implement the flight processing method executed by the UAV shown in FIG. 2 and FIG. 3 and the application scenario shown in FIG. 6A to FIG. 6B by implementing the corresponding processes in the flight processing method and the application scenario.

Referring to FIG. 13, the internal structure of the UAV includes a flight controller 1301, a power assembly 1302, and a communication interface 1303. In some embodiments, the flight controller 1301, the power assembly 1302, and the communication interface 1303 in the UAV can be connected by a bus or other means. The embodiments of the present disclosure adopt the bus connection. The flight controller 1301 may be the computing core and the control core of the UAV, which is suitable for implementing one or more operating configuration instructions and, more specifically, suitable for loading and executing one or more flight processing instructions to realize the corresponding workflows and functions. The power assembly 1302 may be a flight support component of the UAV, and can be used to realize the flight of the UAV. The communication interface 1303 may be a medium for realizing interaction and information exchange between the UAV and external devices.

In some embodiments, the flight controller 1301 can be configured to obtain the clearance permission file of the target flight restriction area from the server, the clearance permission file being generated by the server in response to the flight clearance application information of the target flight restriction area obtained from the smart terminal; and removing the flight restriction of the UAV in the target flight restriction area based on the clearance permission file.

In some embodiments, the flight controller 1301 may be further configured to extract the target flight restriction area information based on the clearance permission file, obtain the current location information of the UAV, and execute the clearance permission file to remove the flight restriction of the UAV in the target flight restriction area when the position indicated by the current position information of the UAV is within the target flight restriction area indicated by the target flight restriction area information, and the target flight restriction area is within the flight restriction area indicated by the built-in flight restriction information of the UAV.

In some embodiments, the flight controller 1301 may be further configured to extract the clearance identification used to identify the UAV based on the clearance permission file, obtain the UAV identification of the UAV, compare the clearance identification with the UAV identification to determine whether the clearance identification is consistent with the UAV identification, and execute the clearance permission file to remove the flight restriction of the UAV in the target flight restriction area based on the clearance permission file if the clearance identification is consistent with the UAV identification.

In some embodiments, flight controller 1301 may be further configured to extract the user information based on the clearance permission file, obtain the control user information of the UAV, compare the user information with the control user information of the UAV to determine whether the user is the control user of the UAV, and execute the clearance permission file to remove the flight restriction of the UAV in the target flight restriction area based on the clearance permission file if the user is the control user of the UAV.

In some embodiments, flight controller 1301 may be further configured to extract the validity period of the clearance permission file based on the clearance permission file, determine whether the current date is within the validity period, and execute the clearance permission file to remove the flight restriction of the UAV in the target flight restriction area based on the clearance permission file if the current date is within the validity period.

In some embodiments, flight controller 1301 may be further configured to download the clearance permission file from the server based on the UAV identification, or download the clearance permission file from the server based on the control user information of the UAV.

Consistent with the present disclosure, the flight restriction of the UAV can be removed in the target flight restriction area in an electronic operations, and the control device can directly download the clearance permission file from the server, which eliminates the manual review process, making the flight restriction removal process of the UAV more efficient. Further, the safety of the flight of the UAV can be controlled based on the safety policy in the clearance permission file, which ensures the flight safety of the UAV.

An embodiment of the present disclosure provides a server, which can be used to implement the flight processing method executed by the server shown in FIG. 4 and the application scenario shown in FIG. 7A to FIG. 7D by implementing the corresponding processes in the flight processing method and the application scenario.

Referring to FIG. 14, the internal structure of the server includes a processor 1401, a network interface 1402, and a computer storage medium 1403. In some embodiments, the processor 1401, the network interface 1402, and the computer storage medium 1403 in the server can be connected by a bus or other means. The embodiments of the present disclosure adopt the bus connection. The network interface 1402 may be a medium for realizing interaction and information exchange between the server and the external devices. The processor 1401 (or central processing unit (CPU)) may be the computing core and control core of the server, which is suitable for implementing one or more instructions and, more specifically, suitable for loading and executing one or more flight processing instructions to achieve the corresponding workflows and functions. It can be understood that the computer storage medium 1403 may be a memory device in the server for storing programs and data. It can be understood that the computer storage medium here may include the built-in storage medium of the server, and of course, it may also include the extended storage medium supported by the server. The computer storage medium can provide storage space, and the storage space can be used to store the operating system of the network device. In addition, one or more instructions suitable for being loaded and executed by the processor can be stored in the storage space. These instructions may be one or more computer programs (including program codes). It should be noted that the computer storage medium here may be a high-speed random-access memory (RAM), or a non-volatile memory, such as one or more disk memories. In some embodiments, the computer storage medium may also be one or more computer storage mediums located far away from the foregoing processor.

In some embodiments, the processor 1401 can be configured to execute the program instructions stored in the computer storage medium. When executed by the processor 1401, the program instructions can cause the processor 1401 to obtain the flight clearance application information submitted by the smart terminal, the flight clearance application information being generated by the smart terminal based on the designated target flight restriction area, generate a clearance permission file for the target flight restriction area in response to the flight clearance application information, and send the clearance permission file to the control device such that the control device can remove the flight restriction of the UAV in the target flight restriction area based on the clearance permission file.

In some embodiments, the processor 1401 can be configured to, in response to the flight clearance application information, determine whether the flight restriction removal conditions are met. If the flight restriction removal conditions are met, the application for clearance the flight can be approved, and the clearance permission file for the target flight restriction area can be generated.

In some embodiments, the processor 1401 can be configured to display the flight clearance application information on the interactive interface, determine whether the approval instruction for the flight clearance application information is received, and determine that the flight clearance application information meeting the preset conditions if the approval instruction for the flight clearance application information is received.

In some embodiments, the processor 1401 can be configured to analyze the flight clearance application information, determine whether the analyzed information meets the flight restriction removal conditions for the target flight restriction area, and consider the flight restriction removal conditions for the target flight restriction area are met if the analyzed information meets the flight restriction removal conditions for the target flight restriction area.

In some embodiments, the processor 1401 can be configured to analyze the flight clearance application information, and determine whether the analyzed flight coordinate range falls within the coordinate range of the target flight restriction area; or, analyze the flight clearance application information, and determine whether the analyzed UAV identification is the identification of a UAV that has been legally registered; or, analyze the clearance permission file, and determine whether the user information obtained by the analysis is the information of a legitimate control user.

Consistent with the present disclosure, the server can generate the clearance permission file, and the smart terminal and the control device can view or download the clearance permission file at the same time, thereby realizing the entire electronic operation, eliminating the need for users to request the control device to remove the flight restriction, making the business process more efficient.

An embodiment of the present disclosure provides a smart terminal, which can be used to implement the flight processing method executed by the smart terminal shown in FIG. 5 and the application scenario shown in FIG. 8A to FIG. 8C by implementing the corresponding processes in the flight processing method and the application scenario.

Referring to FIG. 15, the internal structure of the smart terminal includes a processor 1501 and a memory 1502. The processor 1501 may be the computing core and control core of the smart terminal, which is suitable for implementing one or more instructions and, more specifically, suitable for loading and executing one or more flight processing instructions to achieve the corresponding workflows and functions. The memory 1502 may be a memory device in the smart terminal for storing programs and data. The memory can provide storage space, and the storage space can be used to store the operating system of the smart terminal. In addition, one or more instructions suitable for being loaded and executed by the processor can be stored in the storage space, and these instructions may be one or more program codes.

In some embodiments, the processor 1501 can be configured to execute the program instructions stored in the memory 1502. When executed by the processor 1501, the program instructions can cause the processor 1501 to obtain the target flight restriction area designated by the user; and generate the flight clearance application information based on the target flight restriction area designated by the user, and send the flight clearance application information to the server. The flight clearance application information can be used to instruct the server to generate a clearance permission file for the target flight restriction area based on the flight clearance application information. The clearance permission file can be used to instruct the AUV to remove the flight restriction in the target flight restriction area.

In some embodiments, the program instructions can further cause the processor 1501 to obtain the area information set by the user on the area map displayed on the user application interface, the area information of the flight restriction area being marked on the area map displayed on the user application interface; or, obtain the area listed as the flight restricted area selected by the user on the user application interface.

In some embodiments, the program instructions can further cause the processor 1501 to determine whether the target flight restriction area designated by the user is a flight restricted area; and generate the flight clearance application information if the target flight restriction area designated by the user is the flight restricted area. In this way, the user can submit the flight clearance application information on the target flight restriction area through the smart terminal, realize the entire electronic operation, which makes the business processing process more efficient.

For the specific implementation of the corresponding structure in the embodiments corresponding to FIG. 12 to FIG. 15, reference may be made to the description of the relevant content in the embodiments corresponding to FIG. 1 to FIG. 8, which will not be repeated here.

Those skilled in the art shall understand that some or all steps in various methods described in the embodiments above may be accomplished by a program instructing relevant hardware to perform certain steps. The program can be stored in a computer-readable storage medium. The storage medium may include: a read only memory (ROM), a random access memory (RAM), a magnetic disk, or an optical disk, etc.

The above are only alternative implementations of the present disclosure, but the scope of protection of the present disclosure is not limited to these. Any person skilled in the art can easily think of changes or replacements within the technical scope disclosed in the present disclosure, which should be covered by the protection scope of the present disclosure. Therefore, the protection scope of the present disclosure shall be subject to the protection scope of the claims.

What is claimed is:

1. A flight processing method applied to a control device of an unmanned aerial vehicle (UAV), comprising:
obtaining a clearance permission file of a target flight restriction area from a server, the clearance permission file being generated by the server in response to flight clearance application information of the flight restriction removal conditions obtained from a smart terminal; and
removing flight restrictions of the UAV in the target flight restriction area based on the clearance permission file.

2. The method of claim 1, wherein:
the clearance permission file records target flight restriction area information.

3. The method of claim 1, wherein:
the clearance permission file records one or more of a UAV identification, user information, and a validity period of the clearance permission file.

4. The method of claim 1, wherein before removing the flight restrictions of the UAV in the target flight restriction area based on the clearance permission file, further comprising:
extracting the target flight restriction area information based on the clearance permission file;
obtaining current position information of the UAV; and
removing the flight restrictions of the UAV in the target flight restriction area based on the clearance permission file when the position indicated by the current position information of the UAV is within the target flight restriction area indicated by the target flight restriction area information, and the target flight restriction area is within a flight restriction area indicated by built-in flight restriction information of the UAV.

5. The method of claim 1, wherein before removing the flight restrictions of the UAV in the target flight restriction area based on the clearance permission file, further comprising:
extracting a clearance identification used to identify the UAV based on the clearance permission file;
obtaining the UAV identification of the UAV;
comparing the clearance identification with UAV identification to determine whether the clearance identification is consistent with the UAV identification; and
removing the flight restrictions of the UAV in the target flight restriction area based on the clearance permission file if the clearance identification is consistent with the UAV identification.

6. The method of claim 1, wherein before removing the flight restrictions of the UAV in the target flight restriction area based on the clearance permission file, further comprising:
extracting user information based on the clearance permission file;
obtaining control user information of the UAV; and
comparing the user information with the control user information of the UAV to determine whether the control user information corresponds to a legitimate cleared user; and
removing the flight restrictions of the UAV in the target flight restriction area based on the clearance permission file if the user indicated by the control user information is the legitimate cleared user.

7. The method of claim 1, wherein before removing the flight restrictions of the UAV in the target flight restriction area based on the clearance permission file, further comprising:
extracting the validity period of the clearance permission file based on the clearance permission file;
determining whether a current date is within the validity period; and
removing the flight restrictions of the UAV in the target flight restriction area based on the clearance permission file if the current date is within the validity period.

8. The method of claim 1, wherein obtaining the clearance permission file of the target flight restriction area from the server includes:
downloading the clearance permission file from the server based on the UAV identification; or,
downloading the clearance permission file from the server based on the control user information of the UAV.

9. The method of claim 1, wherein:
the control device is disposed on the UAV, or the control device is disposed on a ground control terminal used to control the UAV.

10. A flight processing method applied to a server, comprising:
obtaining flight clearance application information submitted by a smart terminal, the flight clearance application information being generated by the smart terminal based on a designated target flight restriction area;
generating a clearance permission file for the target flight restriction area in response to the flight clearance application information; and
sending the clearance permission file to a control device for the control device to remove flight restriction of a UAV in the target flight restriction area based on the clearance permission file.

11. The method of claim 10, wherein:
the flight clearance application information includes target flight restriction area information.

12. The method of claim 10, wherein:
the flight clearance application information includes one or more of user information, a UAV identification, and a validity period of the flight clearance application.

13. The method of claim 10, wherein generating the clearance permission file for the target flight restriction area in response to the flight clearance application information includes:
determining whether flight restriction removal conditions for the target flight restriction area are met in response to the flight clearance application information; and
passing the flight clearance application and generating the clearance permission file for the target flight restriction area if the flight restriction removal conditions for the target flight restriction area are met.

14. The method of claim 13, wherein determining whether flight restriction removal conditions for the target flight restriction area are met in response to the flight clearance application information includes:
displaying the flight clearance application information on an interactive interface;
determining whether an approval instruction for the flight clearance application information is received; and
determining the flight restriction removal conditions for the target flight restriction area are met if the approval instruction for the flight clearance application information is received.

15. The method of claim 13, wherein determining whether flight restriction removal conditions for the target flight restriction area are met in response to the flight clearance application information includes:
analyzing the flight clearance application information and determining whether the analyzed information meets the flight restriction removal conditions for the target flight restriction area; and
determining the flight restriction removal conditions for the target flight restriction area are met if the analyzed information meets the flight restriction removal conditions for the target flight restriction area.

16. The method of claim 15, wherein analyzing the flight clearance application information and determining whether the analyzed information meets the flight restriction removal conditions for the target flight restriction area includes one or more of:
analyzing the flight clearance application information and determining whether a flight coordinate range obtained by the analysis falls within a coordinate range of the target flight restriction area;
analyzing the flight clearance application information and determining whether the UAV identification obtained by the analysis is an identification of a UAV that has been legally registered; and
analyzing the flight clearance application information and determining whether the user information obtained by the analysis is information of a legitimate control user.

17. A flight processing method applied to a smart terminal, comprising:
obtaining a target flight restriction area designated by a user;
generating flight clearance application information based on the target flight restriction area designated by the user, and sending the flight clearance application information to a server, wherein
the flight clearance application information is used to instruct the server to generate a clearance permission file for the target flight restriction area based on the flight clearance application information, and the clearance permission file is used to remove flight restrictions of a UAV in the target flight restriction area.

18. The method of claim 17, wherein obtaining the flight clearance application information designated by the user includes:
obtaining area information set by the user on an area map displayed on an user application interface, the area information of a flight restriction area being marked on the area map displayed on the user application interface; or
obtaining an area listed as a flight restricted area selected by the user on the user application interface.

19. The method of claim 17, wherein generating the flight clearance application information based on the target flight restriction area designated by the user includes:
determining whether the target flight restriction area designated by the user is the flight restricted area; and
generating the flight clearance application information if the target flight restriction area designated by the user is the flight restricted area.
